(19) United States
(12) Patent Application Publication
(10) Pub. No.: US 2003/0055667 A1
(43) Pub. Date: Mar. 20, 2003

(54) Information system and method

(76) Inventors: Flavio Sgambaro, Castelcucco (IT); Maria Antonietta Sgambaro, Maser (IT)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 10/204,669

(22) PCT Filed: Feb. 23, 2001
(86) PCT No.: PCT/IB01/00401

(30) Foreign Application Priority Data
Feb. 23, 2000 (GB) 0004303.4
Dec. 7, 2000 (GB) 0029862.0

(51) Int. Cl. G06F 17/60

(52) U.S. Cl. 705/1

(57) ABSTRACT

Manufacturers U1, U2, U3 supply product or service information to a central database (24). Each product or service carries a unique identifier and customers (32-38) can read the identifier and access the information held on the database (24). Preferably the information is certified by a keeper A of the database (24).

This invention relates to a system and method for providing information from a number of unconnected undertakings to an end user via a resource; and in particular to a system and method for certifying the information pertaining to specific goods or services where the information is provided by the undertakings via the resource.

This invention also relates to a system and a method for supplying information petaining to specific identified item of product or service to a user, where the information is provided by undertakings via a resource, in order to supply information before the user buys the specific item. From the moment the item of product or service becomes available and is displayed for sale, the user (would-be purchaser) is offered interactive features to assist him to determine his decision and to enter into a transaction with the undertaking, by means of a dealing system that allows him to buy customised products or services. In turn undertakings have provided to them, interactive features to enable them to update and customise their selling proposals and their production. This information need not be certified, although this is preferred.

Conventional certification methods are in widespread use such as the CE mark. However, these methods are limited in that the only information which can be supplied is what is placed on the package. This is often limited to minimum legal requirements. In order to obtain other information on the product or service, the undertaking providing the product or service concerned must be contacted direct. This may prove difficult and, even if successful, there is no certainty that the information supplied is truthful, accurate and up-to-date.

There is also no shortage of information sources. Books, catalogues, magazines, radio and television advertisements, newspapers and internet-based information sources bombard the consumer with information. However, some of these information sources do not give the user sufficient time to consider the information and/or to make objective judgements about the quality of the products, services and so on to which the information relates. Some of these sources of information are not capable of providing up-to-date information and, in all cases, where information is sourced from the supplier of the goods, services and so on, the consumer is still unsure whether the information is completely truthful. Also, the systems do not provide immediate access to the information on a particular product or service, but usually require a degree of searching by the user, and there can be uncertainty over whether the retrieved information relates to the specific lot or batch of goods.

Methods of providing flow information on products and services are in widespread use, such as those via a web-site resource. However, the information provided may be virtual, that means that the product or service may not necessarily exist when the product or service is promoted.

Some methods combine information provided via remote data resource with information linked to goods already identified, by smart tags for example, but these methods do not provide information on items before sale, only after. Further, those methods are not conceived to supply interactive features for customising sale and purchase, and updating sale features.

This kind of method is used, for example, to enable a store to know when it needs to put more products on shelves; to enable a consumer to know how long to cook the food; to know how many bean cartons are stored in the refrigerator; to know how an empty pack can be recycled, or to know where the product is at a specific moment. Under each aforesaid case, flow information may be available via a remote data resource, during the use of the product (selling, cooking, storing, recycling . . . ), in any case, after having bought it. This flow information cannot be provided just for the purpose to imform a user about each product's characteristics before buying it.

For technical reasons, based up on the way information is stored on a memory chip, whose code is used to identify a single product, the information on this product is limited, because the chip can only store an extremely small amount of textual information. A 96 bit number of a smart tag can store 79 trillion, trillion, trillion (USA trillion) numbers in binary, but can store little textual information (around 30 characters). The code is an “address”. It tells the computer where it should go to find information on the Internet or World Wide Web. Information can be supplied via a remote resource, e.g. over the Internet, but there are problems such as the high cost of supplying dedicated cables to transmit information for those who want to use this technology. Even when using telephone cables, the modem that receives information is always a fixed modem part of the product on sale, and may not be used without buying the whole p.c.

We have realised that a mobile wireless communicator suitably equipped with an antenna hooked up to a smart tag built into the goods for sale, will allow the user, via a resource, to be supplied with the specific information and to deal, using the resource's interactive features, to make a customised purchase.

Thanks to this invention, which offers speedy interactive features in relation to specific items of available products and services, a user may customise his choice and also an undertaking may easily update its offer features and customise its production.

It is one object of the present invention to provide a method and system whereby reliable information (i.e. information which has been certified to be real, truthful and lawful) relating to, for example, products and services can be obtained.

According to a first aspect of the present invention, there is provided a method for providing data from a number of separate undertakings via a resource to an end user, where each piece of data represents information from only one undertaking, the data is stored at the resource and each piece of data is assigned an identification code, said identification code is supplied to end users and end users are provided with particular data relating to the identification code by providing said identification code to the resource.

According to a second aspect of the invention, there is provided a method of certifying a product or service provided by an undertaking characterised in that the undertaking is examined for suitability by the certification company, wherein the examination comprises at least one of a study of the place of business of the undertaking a study of the products or services provided by the undertaking, a study of comments provided by the users of the undertaking's goods or services and is suitable to consider the quality or other aspects of said undertaking's goods or services; the information is provided from at least one undertaking to a resource; each piece of information is given an identication code, and the information is made available to end users by the resource providing each undertaking with one or more identification codes which identify the goods or services in question. This provides a method of certifng a product or service wherein the undertaking is examined for suitability by the certification company.

According to a third aspect of the invention, there is provided a system for providing data from a number of separate undertakings via a resource to an end user, characterised in that there are means for storing data, consisting of items of information, provided by a number of separate undertakings where each piece of data represents information from only one undertaking, means for assigning each piece of data a unique identification code, means for supplying said identification code to said end user, means for allowing said end user to supply said identification code to the resource, and means for providing the end user with data corresponding to that identification code.

The users may be ultimate consumers of the goods or services but may also be retailers or other interested in the particular goods and services so certified.

The certification aspect of the present invention may also be consolidated by the use of a Trade Mark as well as the method in order to give high end user awareness of the system and ensure its widespread acceptance and use.

The examination usually comprises at least one of a study of the place of business of the undertaking, a study of the products or services provided by the undertaking, a study of comments provided by the users of the undertaking's goods or services and is suitable to consider their quality or other aspects of said undertaking's goods or servics. The information is provided from at least one undertaking to a resource. Each piece of information is given an identification code and the information is made available to end users by the resource providing each undertaking with one or more identification codes which identify the goods or services in question.

The information from a number of separate undertakings can be pooled into a resource, which can in turn be accessed easily by a high proportion of interested parties without undue effort, and whereby the information contained in the resource can be verified as accurate before the supply of information to the end users.

The present invention is particularly suitable for goods and services that are difficult to distinguish from each other. A car from one manufacturer is easy to distinguish from the car of another manufacturer and the benefits of each can be assessed. However, there are products that are difficult to tell from others—called homogeneous products. For example, tea, coffee and pasta are difficult for the common man to distinguish from each other. This makes it very difficult for a small company or a new company (that believes it has a good product) to beat the big brand owners. The consumer will generally buy the familiar brand and so a large part of the price that they pay is for the branding. The cost of advertising and promotion required to create a competing brand will be much too high for a small company. By use of the inventive system a company can strengthen its image and become a serous player in a market. Entry to a market is facilitated because the user doesn't have to buy the brand.

The invention, however, provides a means to teach the consumer how to appreciate a quality product or service. Comparisons between the different products or services from participating companies can be made. It thus provides a tool by which the consumer can learn different features of apparently similar products.

Alternative methods of doing this all have disadvantages. For example, if the manufacturer publishes a brochure it will be expensive to print and distribute, it will be hard to relate to individual products and it does not provide an easy way to compare between products. A telephone information line is very exensive to maintain and is limited to voice information—there is no possibility to send photographic information, for example. Printing the information on the packaging has the problems that there may be too little space and the information cannot be readily updated. Packaging for foodstuffs is often printed in very large batches to reduce costs. The producer will usually not be able to predict when the specification of goods will change (e.g. proportions of coffee from South America and Africa). Consequently, he will either run out of packaging or have to discard packaging both of which are inconvenient and expensive. By printing the packaging in a large batch with a unique code on each package individual information can then be supplied. This information need not be restricted to information regarding the product, but could also include details of competions or advertising etc. The unique code could also be used as a prize code in such a competition.

According to another aspect of the invention, there is a method for providing data from undertakings via a resource, or from a number of separate undertakings via a resource, to an end user, where each item's data represents a specific information from the undertaking who is providing the item. Data is stored and codified at the resource. That codification is effected by means of a unique key, for the data storage, in the resource's database, where the unique key code may be the smart tag code (item of product or service unique code). Tags, with their codes, are supplied to undertakings; they build each codified tag onto each specific item of product or service (the service may be provided in a packaging or other material support, that makes it physically possible to handle), and each smart tag code, or unique code, is supplied to users who may access the resource to receive information on a specific item of product or service, and so make if desired his customised purchase. In turn the undertaking may be provided with information by the user via the resource. By receiving immediate information on consumer preference, the undertaking is able to update its offers and customise its production more effectively.

Yet another aspect of the present invention is a method characterised in that the information is provided from at least one undertaking to the resource, and the information is made available to end users by the resource providing each undertaking with one or more smart tags and their codes, where each code identifies the goods or service in question, and where a smart tag is attached to the product or source by the undertaking. Each smart tag is provided to each undertaking with one or more codes in a way that the smart tag is identified by a unique code and wherein said smart tag code is combined with the web site's URL. The smart tag is hooked up to an antenna built into a WAP or other web browser mobile, that is used by a user to receive information on each specific product or service item by means of the resource, via the combined codification supplied by means of the smart tag. The combined codification is received from the antenna, and is supplied to users to enable them to access the resource and receive specific item related information such as general information, dealing information, sale information. In turn the user may provide the resource with information on his dealing preference, by means of filing the list of products he is going to buy, after having evaluated the undertaking's available offers, and buying goods by virtual payment. Undertakings will be able to know via the resource, the kind and quantity of items sold. This purchase information will be stored in the resource in addition to the specific product or service unique code. In turn the undertaking may provide updated or new dealing features, supplying this information to the resource and codifying this information on new products and services, or modifying the information stored on specific goods still on sale.

Further there is provided a system for providing data from a number of separate undertakings via the resource to an end user, characterised in that there are: means for storing information, that may consist of general information, dealing information, selling information provided by at least one undertaking, where a specific information referred to a specific item is an information provided by the undertaking who provides also the item, means for storing and codifing each information with a unique code, where said codification may corresponds to a unique key, and where the unique key code may be the smart tag code, or product or service unique code; means for supplying said identification code to end user, means for equipping a mobile with an antenna hooked up to smart tags; and means for providing said information to end user WAP or other web browser mobile equipped with said antenna, which allows the end user to receive information on each specific product or service, when the specific product or service becomes available for sale and is placed nearby user (to receive radio frequency). Conversely means for providing data to the undertakings via the resource, is characterised in that there are means for storing information on each unique code pertaining to specific goods, that may consist of dealing choice information and purchase information supplied at least by one user, where item's information represents an information from only the user who is providing the information; means for providing updated dealing information to user, pertaining to new items or to product and service still on sale; and for storing information on the item's unique code.

The user may be either the ultimate consumer of the goods and/or services or retailers or others interested in the particular goods/services whose they need to receive information on each specific product or service when it becomes available for sale and is stored e.g in a warehouse.

The information from a number of separate undertakings can be pooled into a resource, which can in turn be accessed easily by a high proportion of interested parties without undue effort.

By alternative methods, the information may be linked to an identified specific product or service, e.g. thanks to a smart tag built into the product, where the smart tag's chip may transmit identification numbers, but the information transmitted via remote data, is actually available and receivable by a user only after having bought the product. If we consider to assigning a resource address, together with the unique code to each smart tag and building the smart tag onto items (product or service), the specific information stored in an undertaking's resource may be transmitted to a web browser mobile equipped with an antenna hooked up to the smart tag.

By means of the method and system hereby described, a new technical contribution is made, and a new service is delivered when a user is physically in contact with the product or service (the sevice provided e.g. in a packaging or other material support that makes it physically capable of being handled), in a way that his vicinity allows him to receive data by radio frequency, so that the system enables the user to be supplied with the producer's information, directly, and only when he desires the information, before deciding to buy goods. This information accessing could also be done to receive explanations on quality, use, product's supply chain (e.g. when retailer has no knowledge on raw material's origin), to deals on the potential sale, and to ask for any available promotions linked to the specific product on sale. In turn, the undertaking can make a variety of promotions, tie-in sales, promotions for new products presentation etc. . . . , and increase easily and quickly the way to exploit promotions by adding new features, updating them and customising its productlon and sale. The user may decide which between the available promotions fits his needs. Those dealing interactive fates may be perfectly organised via the resource server, considering that the user may choose between the kind and number of items available on shelves and the available promotions, and considering that the undertaking may vary promotions by knowing the kind and quantity of items sold. This last information is communicated directly by the user, just using the available interactive features displayed in his mobile, selecting one, or more, of the promotions available, and/or paying for the goods. The user may also buy and pay directly for goods by virtual payment after having listed the goods he wants to purchase without making cash desk payment and suffering long queues.

Thanks to these interactive features, supplied via the resource, the system creates a speedy and efficacious means for buying and selling.

The present invention will now be described, by way of example, with reference to the accompanying drawings, in which:

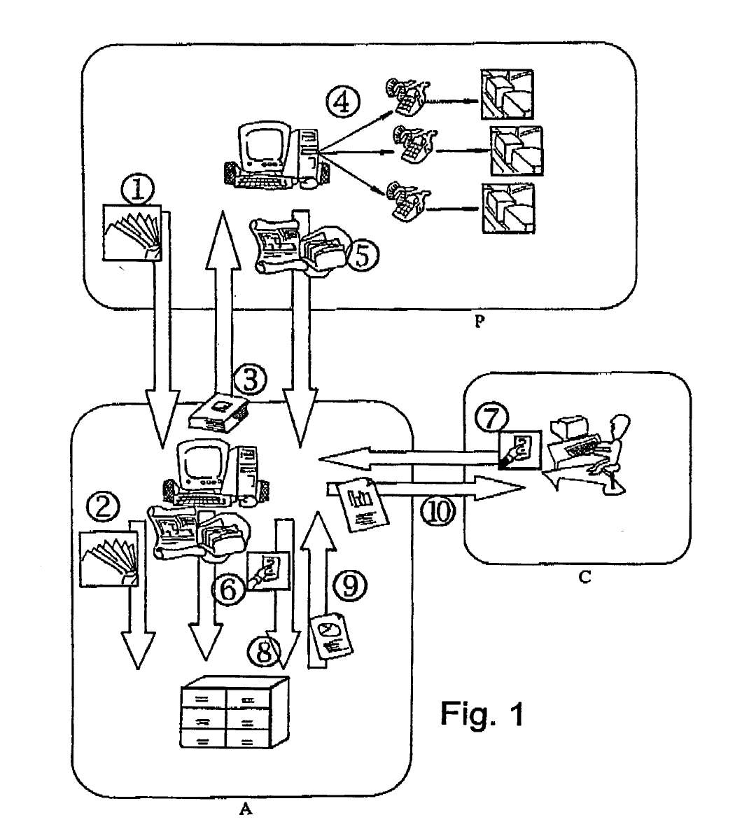

FIG. 1 is a diagram showing the stages involved in a first embodiment of the present invention;

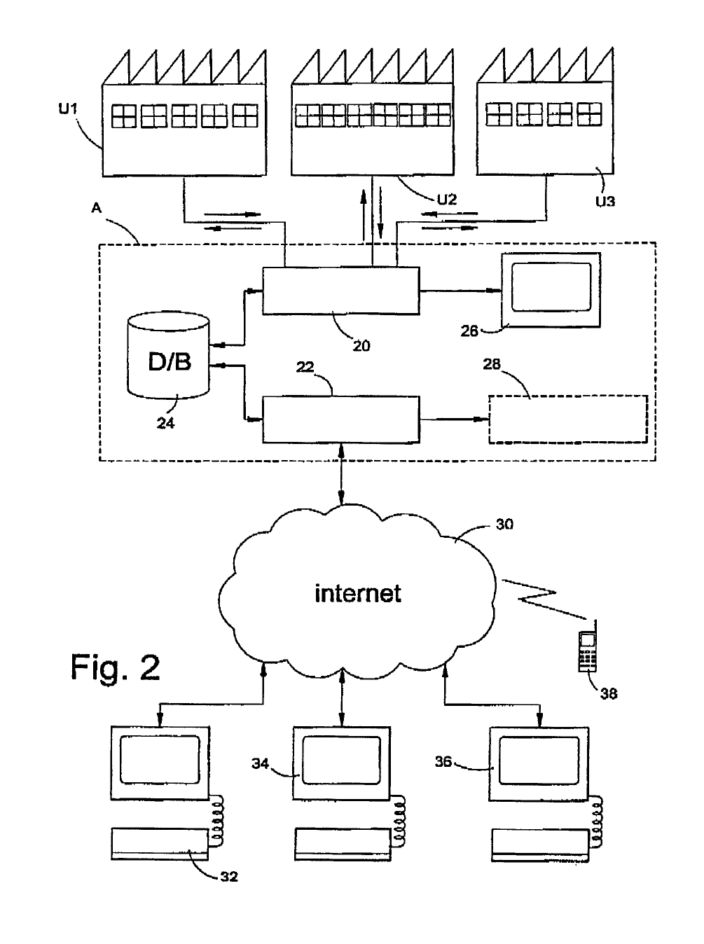

FIG. 2 is a diagram of a computer network according to an embodiment of the invention;

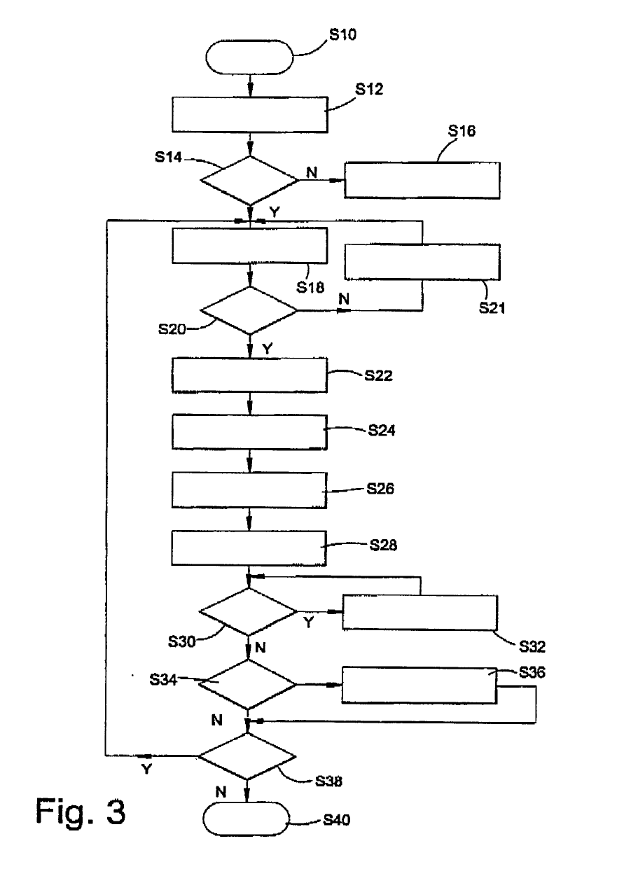

FIG. 3 is a flow chart of the operations of a web server in accordance with the invention;

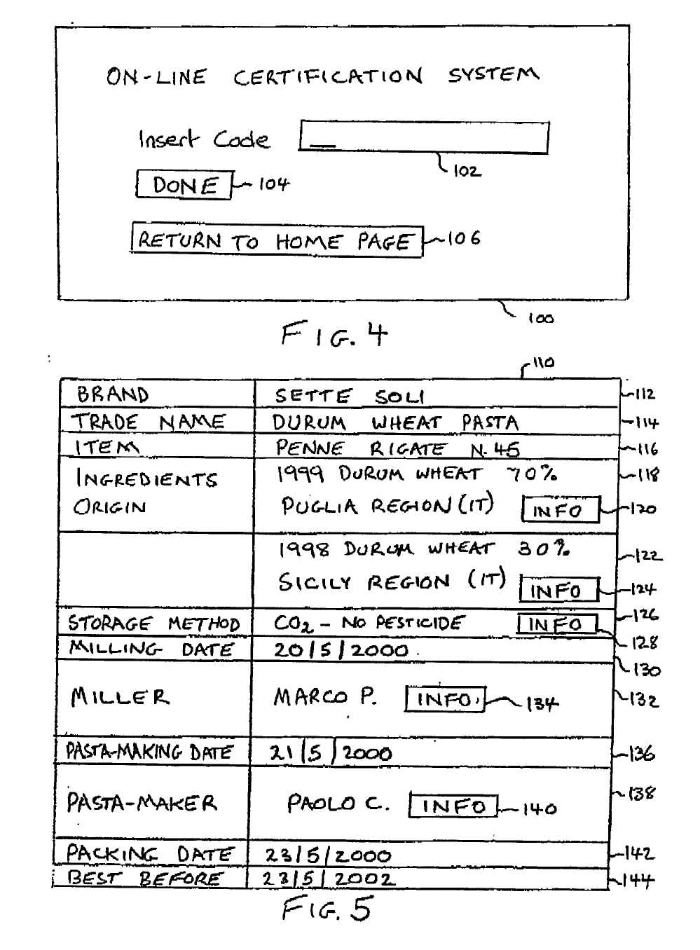

FIG. 4 is a diagram of a first web page displayed from the server of FIG. 3; and

FIG. 5 is a diagram of a second web page displayed from the server of FIG. 3.

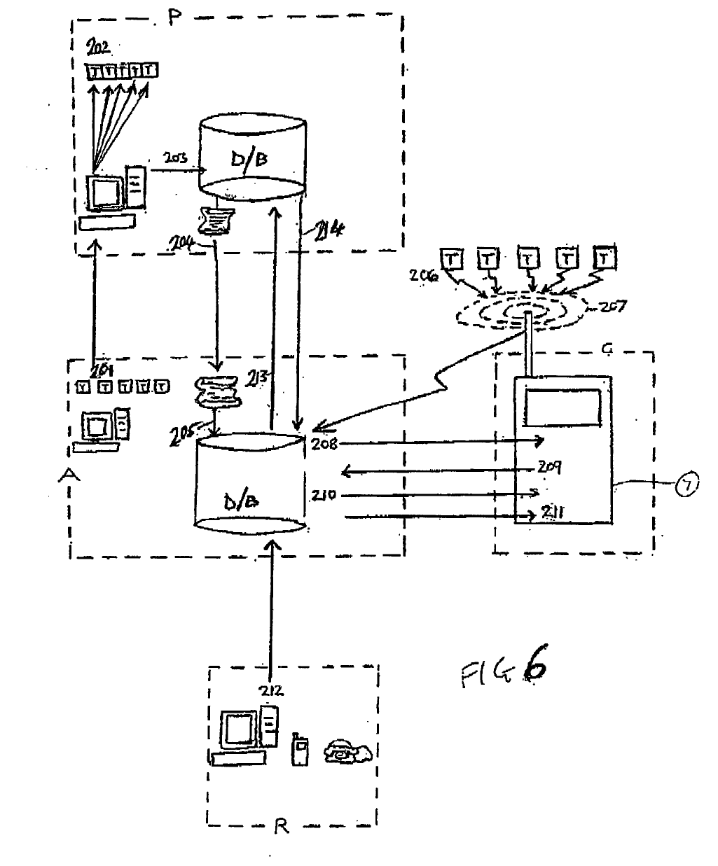

FIG. 6 is a logic diagram showing the stages involved in another embodiment of the present invention;

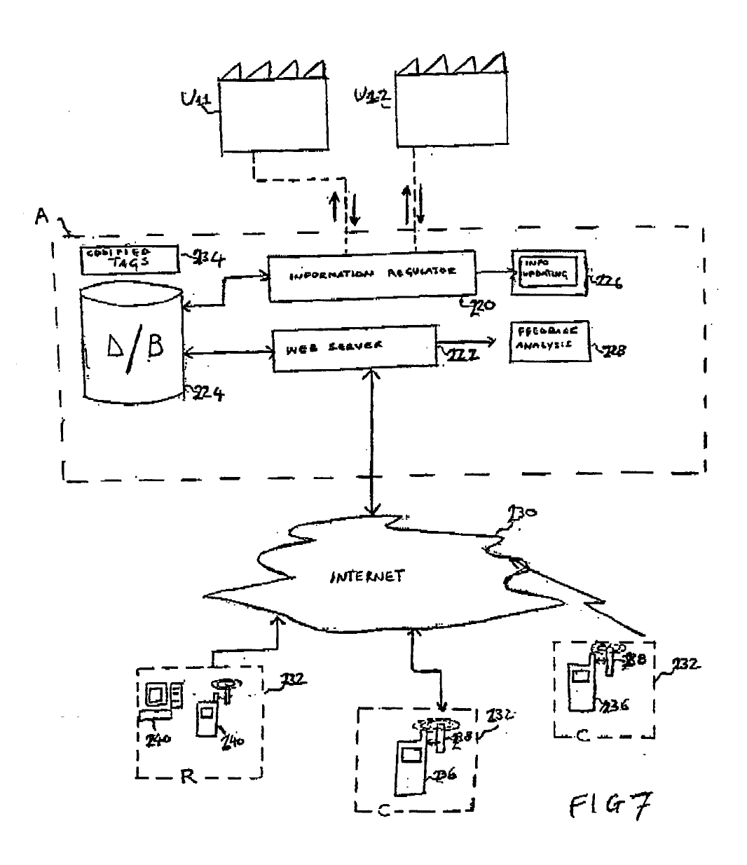

FIG. 7 is a diagram of a computer network according to another embodiment of the invention;

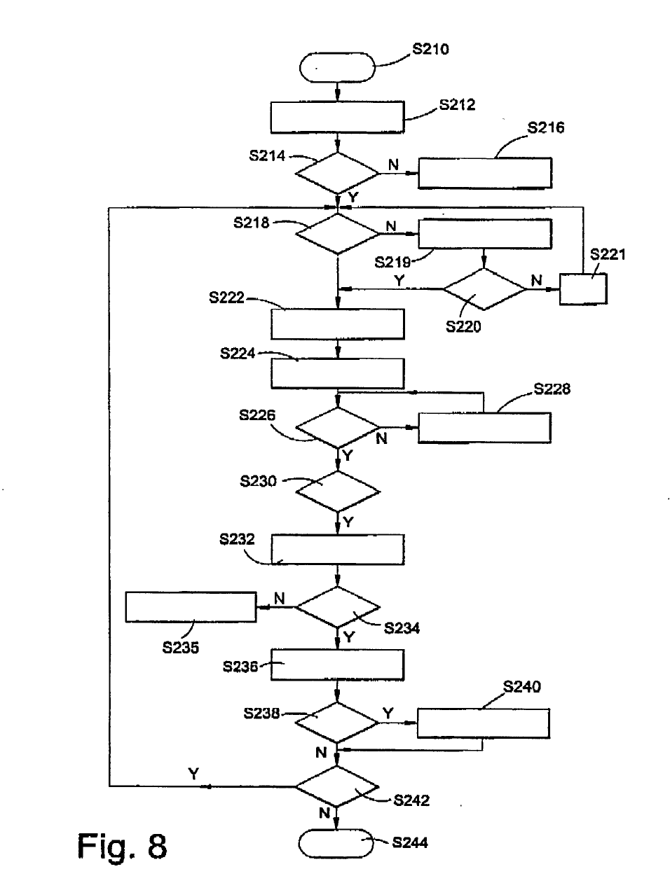

FIG. 8 is a flow chart of the operations of another web server in accordance with the invention;

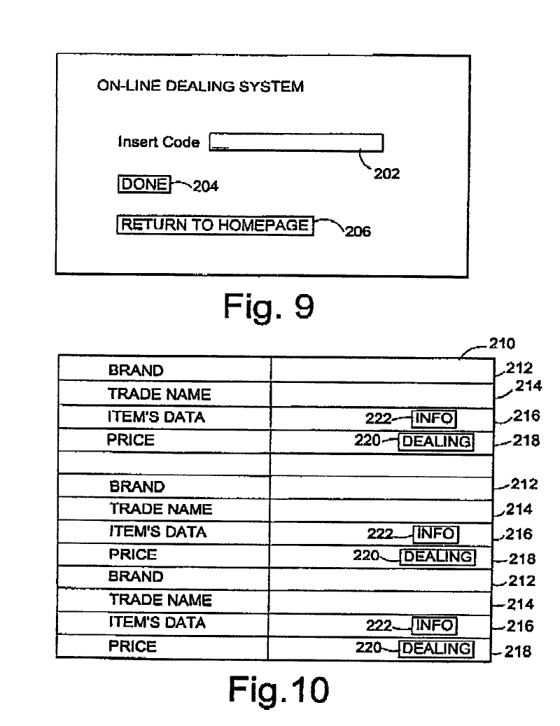

FIG. 9 is a diagram of a first web page displayed from the server of FIG. 8;

FIG. 10 is a diagram of a second web page displayed from the server of FIG. 8.

A first embodiment will be described in the field of product certification, specifically foodstuffs certification, with reference to FIG. 1. In the following description, numbers in parentheses correspond to the circled numbers on the figure. While information is represented in the figure by a picture of a book and storage of information is represented by a filing cabinet, these representations are only illustrative. Undertakings, for example Producers (P) wishing to join the certification scheme contact the certification company (A). Preferably the company itself is ‘certified’. The certification company may be an authorised ISO9000 certificator or it may have agreements to subcontract the certification work to such companies. The certification company (after consultation with the subcontractors as appropriate) chooses which of the undertakings, that apply to be clients of said company, are fit to be certified. This may be done by visiting the establishment(s) of the undertaking to see the production line, or other facilities, by consumer surveys or other means to establish the quality or other requirements of said company to become a client. After the undertaking (P) has successfilly been accepted as a client of said certification company, it provides information regarding itself and its products to said company (1).

The certification company (A) checks that this information is true and lawful and then places (2) this information onto a database which forms part of the resource. For example, the certification company may check for compliance with the relevant ISO standards. The certification of the information content given by the method is built by the reliability that the certification company holds in the market as well as using other recowsed industry certification standards. The undertaking is provided with one or more identification codes by the certification company (3). These codes are loaded into a producer information system specialised in the loading of these codes and their application to the goods or packaging of same from the undertaking which is checked and controlled by the certification company. The producer information system applies said codes to the goods or their packaging (4). Each code may correspond to a nonspecific group of products, a homogeneous group of products or may relate to particular goods within the homogeneous group. Preferably, the code is arranged to correspond to a particular product so that, for example, each individual packet of pasta on the shelves of a supermarket will have its own unique code.

In return, the undertaking provides said company with the information it wishes to have provided to the users (C) for itself and the goods which it produces. The certification company may provide a group of identification codes to each undertaking. When a particular code is to be used, before selling the goods, the undertaking communicates to said company to inform it of the goods sold with the identification code and the information which is specific to those goods (5). This additional information is tested by the certification company to fulfil the same criteria as the information provided at step (1). This step will be discussed in more detail with reference to FIG. 2 below.

This conmuncation may be via electronic automatic link. The certification company will match the information on the particular good or group of goods with the undertaking in the database. Examples of data which could be provided by the system are product descriptions, product photographs, and photographs of the work place and employees etc.

This combined information held on the database within the resource is used to make up an identity card for the goods (6). This is done before the product becomes available for sale. The dynamic combination of the generic and the further information may be done just in time (JIT).

The identification codes added by the undertakings to their products are accompanied by the internet address of a website, which may be the certification company's web-site, which is also part of the resource. The user may then visit the web-site where they will be asked to provide the identification code on the product in question (7). Importantly, this can be done before purchase, for example at a terminal in the supermarket or using a WAP phone. Such a code may be Anna@xxxxxxxxx.ABC, for example. The web site issues a qeury to the database requesting all information which relates to the supplied identification code if the code is valid. The database supplies this and the information is brought together into a single “identity card” for the marked good only when the details ae requested (9). The details are then processed by the web server to appear as one or more web pages, customised to the request of the particular end user (10).

The certification company makes periodic checks on the undertaking to ensure both the continued quality of goods and services together with correct application of identification codes and the like.

FIG. 2 shows a block diagram of an information system in accordance with one aspect of the invention. A plurality of undertakings, shown here as factories U1, U2 and U3 each have an electronic link with the certification company A. The certification company A comprises an information regulator 20, a server 22 for example a web server connected to a database 24, an employee terminal 26 connected to the regulator 20 and an optional feedback analysis system 28 which will be discussed in more detail with reference to FIG. 3 below. The web server 22 is connected via a network 30, for example the internet, to a plurality of user terminals 32, 34 and 36. Any known method of accssing the server 22 may be used, for example a cellular telephone 38 provided with the Wireless Application Protocol (WAP) system.

In operation, the database 24 carries the generic information and the further information provided by the undertakings, U1, U2, U3 regarding their products, services and so on. Codes are provided by the certification company to each of the undertakings and, in return the undertakings provide the specific information relating to the products, services and so on to which these codes will be applied (see step (4) in FIG. 1). This further information is provided electronically to the certification company via, for example, a dial-up telephone connection, a wide area network (WAN), the internet and so on.

Upon receipt of the information, the certification company regulates this information at block 20. The regulation and testing applied to the information may be wholly manual, in which case the information is simply sent to a terminal 26 for consideration by an employee of the certification company (not shown) or may be partially automated. Various techniques could be used to partially automate this step in the process. For example, the information may be compared with previous information supplied by that undertaking in respect of that product, service and so on. If the information differs then it may be sent to the terminal 26 for review by an employee of the certification company. If the information does not differ from that provided previously then it is stored in the database 24 together with the individual code identifying the product, service and so on to which the information relates.

When a user wishes to study information on the product, service and so on he accesses the web server 22 by any suitable means. In the figure, these include a web browser 32 provided in a shop, a web browser at an office 34, a web browser at home 36 or a WAP cellular phone 38. The steps conducted by the web server when the web site is visited will be discussed with reference to FIG. 3 below.

Also shown in FIG. 2 is an optional feedback analysis system 28 connected to web server 22. The purpose of this system is to collect information returned to the certification company A by visitors to the web site. This information can include comments, feedback on quality of goods, services and so on, suggestions for improvement, responses to competitions and so on.

FIG. 3 shows a flowchart whose functions are listed below. The operation of the server when a user visits the site can readily be understood from this figure.

S10 Start

S12 Display menu including whether the certification function is required

S14 Is the certification function required? If YES then S18. If NO then S16

S16 Other Web site functions, for example sales of products and services

S18 Enter Code from product etc.

S20 Is code valid? If YES then S22. If NO then S21

S21 “Invalid Code”

S22 Retrieve generic information from database

S24 Retrieve specific information from database

S26 Combine generic and specific information to generate “Identity Card”

S28 Display Identity Card

S30 Is further information required (see FIG. 5, 124)? If YES then S32 else S34

S32 Retrieve and display further information (standard HTML technology)

S34 Do you want to provide some reply information? If YES then S36 else S38

S36 Enter and store the further information.

S38 Do you want to enter another code? If YES then S18. If NO then S40

S40 End

In addition to the functions already discussed users can also be asked to provide other ancillary information either when they submit the identification code or when they receive the identity card from the resource. This information can be stored in a second database (not shown) holding all information on which products have had information requested, and the ancillary data from each. The data may be used for market study purposes and satisfaction testing etc. These ancillary questions may also be used to conduct market surveys and the like on-line regarding the goods identified by the identification code. They may also be used to target the particular type of advertising which may be placed on the web site for that or future visitors quoting identification codes, or may be placed on the identity card supplied to the end user.

FIG. 4 shows a first web page 100 comprise a field 102 for insertion of an identification code, a “done” button 104 and a “return to home page” button 106. When the visitor to the web site indicates that he wishes to access the certification system, this page will be displayed. He will then insert the code at field 102 and press the done button 104 (or press the RETURN key, etc.). If he does not wish to use the certification system he can press the “return to home page” button 106, Once the user presses the done button 104 the code will be checked by the web server to ensure that the code is valid. In this case, we assume that the code relates to a packet of pasta.

FIG. 5 shows the web page 110 which is then displayed. In the left-hand column of the table are the descriptions of the information provided in the right-hand column. The rows of information 112, 114, 116, 118, 122, 126, 130, 132, 136, 138, 142 and 144 should be self-explanatory. Certain of the information shown in the table is accompanied by an “info” button 120, 124, 128, 134 and 140. If the user wishes further information on, for example, the durum wheat from Puglia region he will click on the info button 120 and more detailed informatlon will be provided. It is well within the competence of the skilled person to prepare the HTML code to provide this information.

A second embodiment will be described, in the field of interactive resource for transactions, system and method, for exchanging information on specific items of product, in his example foodstuffs information, with reference to FIG. 6.

Undertakings, for example Producers (P) wishing to join the interactive information scheme system referred to as a deal, sale and phase system, contact the company who delivers the system, hereinafter X company (A). The X company delivers (201) to the client, after the undertaking has become a client, smart tags (T)(after establishing a relationship with subcontractors as appropriate) where a resource's web-site address, and the smart tag code are stored on them; each smart tag code is a unique code that may identify the item of product. These codes are loaded into a producer information system that keeps track of these codes when smart tags are applied to the goods or their packaging from the undertaking. The producer information system applies smart tags with said codes to the goods or their packaging (202). Each unique code is arranged to correspond to a specific item so that, for example, a code may identify a particular product line of the producer, a particular manufacturing batch, or even the particular item itself such as in the case of a car. The producer information system will match any piece of information pertaining to the particular item, and links the item's unique code with said information pertaining to each specific item of product (203). In return the undertaking (P) supplies X company with said codified information it wishes to have provided to the user (C) for itself and the specific items which it produces, as well as dealing information and/or sale information, pertaining to each specific item. Before selling goods, and when a particular unique code is to be used, the undertaking communicates to said company the items of goods produced together with the unique code applied to the m, and the information which is specific to those items (204).

When the customer purchases direct from the undertaking, the undertaking can accumulate the appropriate information for stock control etc. When the customer purchases from the retailer, for example, the retailer can transmit the information to the undertaking, preferably via the resource, using the product code. This can be supplied in real time or as a batch process, depending on the type of item. The information can then be used by the undertaking to monitor stock at the retailer, for example. The retailer may also collect information from the consumer and pass this on to the undertaking, preferably via the resource.

The X company (A) places (205) this information onto a database which forms part of the resource. As indicated above, the company (A) may provide a certification that all, or part, of the information is correct.

This communication may be via electronic link, X company will store in the database the information pertaining to the particular item, combined with the unique code. Example of data which could be provided by the system are product description, product photographs, and photographs of the workplace etc. . . . , promotions description, multiplicity of sale proposals etc. . . . , purchase description and lists of products on sale, that can be used by would-be purchaser as shopping lists etc. . . .

This information held on the database within the resource is the first part of the interactive information system, provided by the undertaking, for transactions on items on sale. This information is stored in the database before the product becomes available for sale, or before offering it to would-be purchasers.

When a user is near the product he may use his web browser, to receive data from the smart tags applied to items or their packaging (6), entering a direct connection with radio frequency by means of the web mobile or UMTS (7). It will be appreciated that the smart tag may be replaced by a bar code, for example, and the communicator 7 may include a bar code reader and/or a key pad to input the bar code number.

The URL of X company's web site, with the item unique code, is transmitted to an antenna by radio frequency, where the antenna is built in a WAP mobile, or UMTS, or other web browser facilitated mobile telephone, to allow the user (C) to receive information on any specific product item on sale, before buying it, when the user is near the product item.

The user may then ‘visit’ the web-site directly using the WAP mobile telephone, etc., and the specific web pages referring to the specific product, after having entered connection with radio frequency. The resource system comprises the X company's website where all information which relates to the supplied web site's address, and unique code, arc matched in the database. The database supplies this information which is brought into a single item information (208). When dealing and payment information, if required (209) are available, a user may provide his dealing choice information and purchase information, making a list of products he is going to buy (210) and paying goods by virtual, or real payment, after payment data are available (211).

This communication may be via electronic link X company will match said dealing choice and purchase information, together with the item's unique code in its database.

This combined data held on the database within the resource is used to make up the second part of the interactive information system, this time provided by the user, Example of data which could be provided, are number and kind of items purchased, consumer's choices within a multiplicity of sale promotions etc. . . .

X company's database supplies the undertaking with said codified information it wishes to have provided from the user (212) for updating both sale promotions and production taking in account the user's dealing and purchase information.

This communication may be via electronic link. The undertaking will match said dealing choice and purchase information with items unique code in its database.

This combined data held on the undertaking's database is used to make up the third part of interactive information, this time provided by the undertaking to X's resource, for updating promotion on product still on sale (213).

Example of data which could be provided by means of the system are new promotions proposals on product on sale, new combined services etc. . . .

FIG. 7 shows a block diagram of an information system in accordance with an aspect of the invention. A plurality of undertakings, shown here as factories U11, U12 each have an electronic link with the X company A. The X company comprises an information regulator 220, a server 222 for example a web server connected to a database 224, an employee terminal 226 connected to the regulator 20 and optional feedback analysis system 228 which will be discussed in more detail with reference to FIG. 8 below. The web server 222 is connected via a network 230, for example the internet to a plurality of user cellular telephone 232, provided with the Wireless Application Protocol (WAP) system or UMTS or other web browser mobile.

In operation, the database 224 carries the generic information and the further information provided by undertakings U11 and U12 regarding their item of products or services, promotions, dealing and payment and so on.

Smart tags, codified with the web site's URL and item's unique codes 234 are provided by the X company to each of undertakings and, in return, the, undertakings provide the specific information relating to the products, services and so on, to which smart tag will be applied to transmit these information (see step 204 in FIG. 6). Product item, dealing, payment information etc. . . . , is provided electronically to the X company via, for example, a dial-up telephone connection, a wide area network (WAN), the internet and so on.

Upon receipt of the information, the X company regulates this information at block 220. The regulation applied to the information may be wholly manual, in which case the information is simply sent to a terminal 226 for consideration by an employee of the X company (not shown) or may be partially automated.

Various techniques could be used to partially automate this step in the process. For example, the information may be compared with following information supplied by that undertaking after evaluation of feedback information in respect of other product, or service and so on. If the information differs than it may be sent to the terminal 226 for updating by an employee of the X company. The information and the following information are stored in the database 224 together with the unique code identifig the product, service and so on to which the information relates.

When a user wishes to study information on the item of product or service, on promotions and so on, he accesses the web server 222 by connection his WAP or UMTS or other web browser 236, with tag's radio frequency, transmitted via the antenna 238, built in the same mobile. The steps conducted by the web server when the web site is visited will be discussed with reference FIG. 8 below.

Also shown in FIG. 7 is a feedback analysis system 128 connected to web server 222. The purpose of this system is to collect information returned to X company A by visitors of the web site and product or service buyers and retailers. This information can include the kind and quantity of item bought, promotion preference and so on.

FIG. 8 shows a flowchart whose functions are listed below. The operation of the server when a user visits the site can readily be understood from this figure.

S210 Start

S212 Display menu including whether the dealing function is required

S214 Is the dealing function required? If YES then S218. If NO then S216

S216 Other Web site functions, for example sales of products and services, products and services general information

S218 Is the Code available from Radio Frequency ID from product. If YES then S222. If NO the S219 etc.

S219 “Enter Code from product”

S220 Is the code valid? If YES then S222. If NO then S221

S221 “Invalid Code”

S222 Retrieve promotion information combined with the item's data from database

S224 Display item's data and promotion information

S226 Is further information required (see FIG. 10. 220)? If YES 228 else 230

S228 Retrieve and display further information (standard HTML technology)

S230 Do you want to buy item/s? If YES then S232. If NO then

S232 Select the appreciated displayed promotion

S234 Do you want to buy the selected promoted item/s virtually on-line. If YFS then S236. If NO then S235

S235 “Pay at the cashdesk”

S236 Payment function, for example to insert credit card data etc.

S238 Do you want to provide some replay information? If YES then S210 else S242

S240 Enter and store the further information

S242 Do you want to enter another code? If YES then S218. If NO then S242

S244 End

In addition to the functions already discussed, users can also be asked to provide other ancillary information either when they submit the identification code or when they receive the identity card from the resource. This information can be stored in a second database (not shown) holding all information on which products have had information requested, and the ancillary data from each. The data may be used for market study purposes and satisfaction testing etc. These ancillary questions may also be used to conduct market surveys and the like on line regarding the goods identfied by the identification code. They may also be used to target the particular type of advertising which may be placed on the web site for that or future visitors quoting identification codes, or may be placed on the identity card supplied to the end user.

FIG. 9 shows a first web page 200 comprising a field 202 for insertion of an identification code, a “done” button 204 and a “return to home page” button 206. When the visitor to the web site indicates that he wishes to access the system, this page will be displayed. He will then insert the code at field 202 and press the done button 204 (or press the RETURN key, etc.). If he does not wish to use the system he can press the “return to home page” button 206. Once the user presses the done button 204 the code will be checked by the web server to ensure that the code is valid. In this case, we assume that the code relates to a packet of pasta

FIG. 10 shows the web page 210 which is then displayed. In the left-hand column of the table are the descriptions of the information provided in the right-hand column. The rows of information 212, 214, 216, 218 should be self-explanatory. Certain of the information shown in the table is accompanied by an “info” button 222. If the user wishes further information, he will click on the info button 220 and more detailed information will be provide. It is well within the competence of the skilled person to prepare the HTML code to provide this information.

If the user wishes to purchase, he ‘clicks’ on the DEALING button 220.

It will be appreciated that steps may be performed automatically or with a ‘one touch’ operation. Thus, if the user's mobile telephone detects the product code, the user can connect with one touch to the web server 222 (FIG. 7) and automatically provide the product code to go direct to the product data page, step 228, etc.

As indicated above, the systems may provide for the consumer to send comments to the resource. These may include comments after the product or service has been consumed or used, and may prompted by customer surveys, guarantee registrations, etc. The consumer may readily identify the product or service in question by referee to the code, and the resource may provide a facility for the consumer to input information against the code, which can then be passed on to the manufacturer or undertaking, or utilised by the resource as part of the certification procedure when certification is provided.

Although the above embodiments of the method relate to products, it will apply equally to services and it should be appreciated that further modifications and variations will suggest themselves to those versed in the art upon making reference to the foregoing description, which is given by way of example.

1. A method of providing certified information pertaining to a plurality of separate undertakings, characterised by;
examining the undertaking for suitability by a certification company, wherein the examining comprises at least one of a study of the place of business of the undertaking, a study of the products or services provided by the undertaking, a study of comments provided by users of the undertaking's products or services suitable to consider the quality or other aspects of said undertaking's products or services;
providing the information from the undenakings to a resource;
allocating an identification code to each piece of information; and
supplying the information to users in response to the identification code which identifies the goods or services,

2. Method according to claim 1, wherein the resource comprises a database which stores said information together with the identification code, and a web-server which processes user-supplied identification codes and provides the data from said database in the form of at least one web page.

3. Method according to claim 2, wherein the database is a relational database.

4. Method according to any of the preceding claims, wherein the step of supplying the information comprises supplying generic information and further information corresponding to the identification code.

5. Method according to claim 4, further comprising a step of examimining each piece of further information upon supply by the undertakings.

6. Method according to an preceding claim, wherein the identification codes are provided by the undertakings with said products or services.

7. Method according to any of the preceding claims, wherein the user provides ancillary information in addition to said identification code and said ancillary information is stored in the resource.

8. Method according to any of the preceding claims, wherein the resource is linked to each undertaking to receive information and issue identification codes automatically.

9. Method according to any of the preceding claims, further comprising a step of periodically examining each undertaking.

10. A method of providing information from a plurality of separate undertakings via a resource to a user, characterised in that the method comprises:
storing information consisting of generic information, and further information,
assigning each piece of further information a unique identification code,
supplying said identification code to the user,
allowing the user to supply said identification code to the resource, and
providing the user with the generic information and the further information corresponding to that identification code.

11. A method as claimed in claim 10, further comprising a step of examining each of the plurality of undertakings before providing the user with information.

12. A method as claimed in claim 10 or claim 11, further comprising a step of periodically examining each of the plurality of undertakings.

13. A method as claimed in claim 10, claim 11 or claim 12, further comprising a step of examining each piece of further information upon supply by the undertakings.

14. A system for providing information from a plurality of separate undertakings via a resource to a user, characterised in that the system comprises:
means for storing information consisting of generic information, and further information,
means for assigning each piece of further information a unique identification code,
means for supplying said identification code to the user,
means for allowing the user to supply said identification code to the resource, and
means for providing the user with the generic information and the further information coresponding to that identification code.

15. A system as claimed in claim 14, further comprising means for examining each piece of further information upon supply by the undertakings.

16. A method of providing information pertaining to an undertaking or a plurality of separate undertakings characterised by:
supplying to an undertaking by means of a company, which provides an interactive resource (whose features are designed to enter transactions and to update deals on specific identified items), Radio Frequency ID, or smart tags, or similar systems, together with their own identification codes; where the code is used not only to identify each RFID or smart tag, but also for the identification of each item of the undertaking's product or service;
allocating a smart tag or similar, to each item of a product or service, by means of the undertaking's manufacturing process;
storing codified information onto the undertaking's database, by means of the undertaking's information system;
providing said codified information on items, that may consist of genetic information (goods description); dealings information (a variety of sale proposals) and sale information (shopping lists with a variety of items combined, and payment data), from the undertaking to the resource;
equipping a WAP (or a UMTS, or other web browser mobile) with an antenna that may receive data from the smart tags or similar;
supplying information by means of the resource to a user, via said mobile, in response to his information request;
supplying said information by means of the resource to a user, before he buys a product or service;
receiving information from a user about his dealing (or negotiation) choice which consists of the number and kind of items selected from a variety of sale proposals;
storing the user's dealing (or negotiation) choice in the resource, in addition to the unique code pertaining to the item/s selected by the user;
receiving user's purchase information regarding the number and kind of items bought (“so called” shopping list);
storing said user's purchase information in the resource, in addition to the unique code pertaining to the each of items bought;
providing undertaking by means of the resource, with said information regarding the user's dealing choice, and purchase information; and
providing via the resource to the users, the undertaking's updated information about deals (new or different deals, after the undertaking evaluation of the efficacy of its previous deals), pertaining to new products and services, or to the items still on sale and available inside the store.

17. Method according to claim 16 where the resource comprises:
a database which stores; generic information, dealing, and sale information; together with the RFID code (or the smart tag code, or other identification code) which is also the product or service identification or item unique code; and
a web server which processes the user-supplied unique code, and provides the data from said database in form of at least one web page.

18. Method according to claim 16 or 17, where the resource comprises a database which stores the user's dealing choice, and purchase information pertaining to a product or service and its unique code, and provides this data from said database to undertaking database.

19. Method according to claim 16, 17 or 18, wherein the resource database is a relational database.

20. Method according to any of claims 16 to 19, wherein the steps of supplying information comprises supplying goods information, dealings information and sale information to a user, and dealing choice information and purchase information from a user to the undertaking, where any piece of information pertains to a specific item and its unique code,

21. Method according to any of claims 16 to 20, wherein the steps of supplying updated dealing information to a user, either refers to goods still on sale and their unique code, or to new products or services that will be supplied to the shop.

22. Method according to any of claims 16 to 21, wherein the unique code is provided to the resource, by an undertaking, together with generic information, and/or dealing information, and/or sale information.

23. Method according to any of claims 16 to 22, where dealing choice information and purchase information is provided by a user, via the resource, and in turn said information is provided to the undertaking, referring to the item's unique code.

24. Method according to any of claims 16 to 23, wherein the user provides information about his dealing choice, made by himself in order to customise his purchase, and said choice is an ancillary information in addition to the unique code, and said ancillary information is stored.

25. Method according to any of claims 16 to 24, wherein the user provides information about his purchase, and this purchase information is an ancilliary information in addition to the unique code, and this ancillary information is stored.

26. Method according to any of claims 16 to 25, wherein undertaking provides its update information on dealing information, after having evaluated information on user's dealing choice and purchase information.

27. Method according to any of claims 16 to 26, wherein the resource is linked to each undertaking, to receive item information and issue identification codes automatically.

28. Method for providing information from undertakings via a resource to a user, characterised in that the method comprises:
building an identification code and a web site's URL on each smart tag (or RFID, or similar system);
assigning each product or service a smart tag or similar system;
storing information consisting of generic information, dealing information and sale information;
codifying information pertaining to any item of product or service, considering that the unique code (which refers to each item of product or service) way be a unique key for storing information into the database;
equipping a web browser mobile with an antenna hooked up to smart tags, that receives the smart tag's radio frequency;
providing, by means of the smart tag, the web site's URL together with the item's unique code (smart tag code) to the user's WAP (or other web browser mobile) and by means of his WAP (or other web browser mobile) the information pertaining to each product or service via the resource;
providing a user with the information corresponding to that unique code before he buys the product or service;
receiving dealing choice information from a user;
storing a user's dealing choice information in addition to the item's unique code;
receiving purchase information from a user;
storing user purchase information in addition to the item's unique code;
providing undertakings with information about a user' dealing choice and purchase;
updating dealing information stored in the resource, and pertaining to goods still on sale, or to new goods, by means of input from undertakings.

29. A system for providing information from undertakings via a resource to a user; characterised in that the system comprises:
means for assigning to each product or service a RFID tag (or a smart tag, or similar system);
means for assigning to each smart tag (or similar system) an identification code;
means for assigning to each smart tag (or similar system) the web site's URL;
means for storing information;
means for codifying each type of information (general, dealing, sale and purchase information) by means of a unique key into the resource's database;
means for supplying said web site's URL with the identification code (e.g. smart tag code) to a user;
means for equipping a mobile with an antenna hooked up to a smart tag;
means for supplying a user via his WAP (or a UMTS, or other web browser mobile) equipped with said antenna, with the web site's URL and the identification code (smart tag code), via the tag radio frequency, or similar system;
means for allowing a user to receive information from the resource;
means for providing a user with information corresponding to a unique code before he buys a product or a service;
means for receiving the user's dealing choice information;
means for storing in the resource, with the user's dealing choice information, in addition to the item's unique code;
means for receiving purchase information from a user;
means for storing in the resource, the user's purchase information, in addition to the item's unique code;
means for providing undertakings of user's dealing choice information and purchase information via the resource;
means for updating dealing information stored in the resource, pertaining to goods still on sale, or to new goods, by means of undertakings' input.

30. A method or system as claimed in any one of claims 16 to 29, in which at least some of the information accessed by a user has been certified as complying with a publicly recognised standard.

31. A method of obtaining items of information relating to a product or service, the method comprising obtaining a code identifying the product or service, transmitting an enquiry to a database containing the items of information; the enquiry including the identifying code, and receiving from the database an item of information associated with the identifying code.

32. A method of providing a prospective purchaser or a product or service with information relating to the product or service, the method comprising receiving from the purchaser a code identifying the product or service,
transmitting the code to a database containing the code and items of information related to the product or service identified by the code,
receiving from the database an item of information relating to the code,
and transmitting the item of information to the prospective purchaser.

33. A database having stored thereon items of information which each relate to a product or products, each item having associated with it a code identifying the product or products to which the item relates, whereby an item can be accessed via the product code, for use in the method of any one of claims 1 to 13 and 16 to 32 or the system of claim 14 or 15.

34. A mobile communication device having means for reading or interrogating a smart tag, a printed code label, or the like to obtain a substantially unique identifier of a product or service, means for connecting with an information provider via a communications network, means for communicating with the information provider to obtain information related to the identifier and means for supplying the information to a user of the device.

35. A method for providing data from undertakings via a resource, or from a number of separate undertakings via a resource, to an end user, where each item's data represents a specific information from the undertaking who is providing the item

36. A method of providing information from at least one undertaking to a resource, the information being made available to end users by the resource, in which the or each undertaking is provided with one or more codes, where each code identifies a product or service of the undertaking, and where the code is attached to the product or service by the undertaking.

37. A system for providing data from a number of separate undertakings via the resource to an end user, characterised in that there are: means for storing information, that may consist of general information, dealing information, selling information provided by at least one undertaking, where a specific information referred to a specific item is an information provided by the undertaking who provides also the item, means for storing and codifying each information with a unique code, where said codification may corresponds to a unique key, and where the unique key code may be the smart tag code, or product or service unique code; means for supplying said identification code to end user, a communication device usable by the end user to obtain said code and to receive information on each specific product or service, when the specific product or service becomes available for sale and is near the user.

38. A method as claimed in claim 1, 10, 11, 16, 28 or 29, wherein a consumer provides information to the resource concerning product or service quality, satisfaction or the like, the product or service being identified by the code, and the information is stored against the code and/or passed on to the undertaking associated with the code.

39. A method of collating consumer information on a product or service, the method comprising allocating a unique code to the product or service, providing a resource, receiving the information and the respective code from the consumer, storing the information at the resource and/or passing the information to the product manufacturer or service provider.
